(19) United States
(12) Patent Application Publication
(10) Pub. No.: US 2019/0355197 A1
(43) Pub. Date: Nov. 21, 2019

(54) PORTABLE SAFETY APPARATUS

(71) Applicant: SAI LAKSHMI INDUSTRIES PVT. LTD, Karnataka Bangalore (IN)

(72) Inventor: Haresh Mohan Mirpuri, Bangalore (IN)

(21) Appl. No.: 16/469,528

(22) PCT Filed: Dec. 13, 2017
(86) PCT No.: PCT/IN2017/050593

§ 371 Date: Jun. 13, 2019

(30) Foreign Application Priority Data
Dec. 13, 2016 (IN) 201641042544

(51) Int. Cl. G07C 9/00; G08B 5/36

(52) U.S. Cl. CPC G07C 9/00563; G08B 5/36

(57) ABSTRACT

A portable safety apparatus (200) for securing movable object (108) and its associated items includes a housing (202) and an embedded system board (206) affixed in the housing (202). The board (206) includes one or more communication modules and an embedded controller module (206-4). The communication modules include a first communication module (206-1) and a second communication module (206-2). The communication modules communicate information related to each item contained in the movable object (108). Further, the controller module (206-4) and its set of associated embedded firmware components are communicatively connected to the communication modules. A locking/unlocking unit (204) operates a locking mechanism based on one of a first command, a second command, and a third command. A power supply module (210) is connected to the embedded system board (206).

### TECHNICAL FIELD

The present subject matter, generally relates to a system for securing a movable object, and particularly relates to a system and a method for tracking and locking the movable object and its associated items.

### BACKGROUND

When traveling, either long distances or simply to a business meeting, people often pack and unpack items, or carry the items in more than one bag. The items, for example, may include, passports, plane tickets, watches, wallets, keys, medicine, eyeglass cases, security cards, laptop computers, car keys, adapter plugs, cameras, cell phones, and other accessories These items may be left behind when people leave for business meetings, pack the bag for vacation, check out of a hotel, or while preparing for any eleventh-hour activity. Even if such items are not left behind as mentioned in the above scenarios, a person may want to ensure that all such items required for his daily chores are available/ packed before leaving for a trip. Accordingly, it is required to provide a system that can keep a track of all items in the bag. Further, the bag must have a provision that provides improved security in order to prevent the loss or misplacement of the items contained in the bag.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference, like features and components.

FIG. 1 illustrates a system for securing a movable object and its associated items, in accordance with an embodiment of the present subject matter.

FIG. 2 illustrates an exploded view of a portable safety apparatus for securing the movable object and associated items, in accordance with an embodiment of the present subject matter.

FIG. 3 illustrates an example implementation of an embedded system board of the portable safety apparatus of FIG. 2 in communication with an external controller, in accordance with an embodiment of the present subject matter.

FIG. 4A illustrates a flowchart for establishing a secure connection between the external controller and the portable safety apparatus of FIG. 2, and configuring the portable safety apparatus in accordance with an embodiment of the present subject matter.

FIG. 4B illustrates a working of the portable safety apparatus of FIG. 2 in response to a dedicated application of the external controller, in accordance with an embodiment of the present subject matter

FIG. 4C illustrates a locking/unlocking mechanism of the portable safety apparatus of FIG. 2 enabled from one or more control commands, in accordance with an embodiment of the present subject matter.

FIG. 5 is an exploded view of a locking/unlocking unit of the portable safety apparatus of FIG. 2, in accordance with an embodiment of the present subject matter.

### DETAILED DESCRIPTION

The present subject matter relates to tracking of a movable object and its associated items using wireless communication. Tracking involves determining a unique identifier of each item contained in the movable object and alerting an owner of the movable object when one or more of the items are not present in the movable object. Further, the present subject matter provides a locking and unlocking mechanism for securing the items contained in the movable object, and alerting the owner when the movable object is either locked or unlocked.

People often tend to lose and misplace their keys, wallet, and other items inadvertently at home. It is a common problem for many people to misplace, lose, or leave behind personal belongings, including valuables. These valuables may be kept in a secure place at times and may be lost due to the tendency of a person to forget the last instance and place the valuables were kept. This common problem has grown with the increasing number of personal belongings being carried and protected by people day-to-day.

For example, a traveler initially packs every personal belonging that is needed for a trip which may involve a stay at two or more hotels. Upon arriving at the first hotel, the traveler unpacks the personal belongings for use. Then, during the preparation of travel to the second hotel, the traveler re-packs all of his personal belongings, except for a few items that he had missed unintentionally when re-packing, and those might be valuable items. In such circumstances, failing to pack those valuable items may have a serious consequence to health, safety, and the wellbeing of the traveler. Thus, there exists a need for an apparatus, a system and a method that allows tracking, monitoring, and securing items essential for the traveler or any person at any instant of time.

Further, owing to the size of personal belongings, such as keys, passports, plane tickets, watches, wallets, medicine, eyeglass cases, security cards, and their like, it is not uncommon for these personal belongings to be misplaced. Further, if such personal belongings are lost or stolen, it creates an inconvenient and/or a financially risky situation. Thus, there exists a need for an apparatus, a system and a method which automatically warns users when a personal belonging or item is missing from the movable object.

In addition, it may be bothersome and time consuming, at business locations such as offices, warehouses and the like, to search for items such as files, merchandise, keys, wallets, remote control and the like, as valuable employee hours may be lost each year searching for the misplaced items. Thus, there exists a need for an apparatus, a system and a method to provide a simple and convenient mechanism to warn a person when the valuables are removed from their desired place.

Therefore, the present subject matter introduces a system which comprises a portable safety apparatus, an external controller, and a movable object including a plurality of items possessing unique wireless identifiers. The system is designed to assist a user when the user has either misplaced, lost or forgotten a desired item from the movable object. The portable safety apparatus communicates a status of desired items that are overlooked or missed by the user to the external controller. In addition, it indicates a locked or unlocked status to the external controller and provides a visual or an aural reminder to the user.

Further, the lock functionality is for securing the plurality of items contained in the movable object. A lock is provided in the portable safety apparatus to implement the lock functionality. The lock may be controlled remotely by a dedicated application operating on the external controller or by means of a finger print scanner or by a dedicated wireless master key. The external controller is equipped with a wireless communication module to activate the lock.

Further areas of applicability of the present subject matter will become apparent from the detailed description provided hereinafter. It should be understood that the detailed description and specific examples, while indicating the preferred embodiments of the invention, are intended for purposes of illustration only and are not intended to limit the scope of the invention.

It will be readily understood that the components of the embodiments as generally described herein and illustrated in the appended figures could be arranged and designed in a wide variety of different configurations. The described embodiments are to be considered in all respects only as illustrative and not restrictive. The scope of the invention is, therefore, indicated by the appended claims rather than by this detailed description. All changes which come within the meaning and range of equivalency of the claims are to be embraced in their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment. Further, the described features, advantages, and characteristics of the invention may be combined in any suitable manner in one or more embodiments

According to an embodiment of the present subject matter, a portable safety apparatus for securing a movable object and its associated items includes a housing and an embedded system board affixed in the housing. The embedded system board includes one or more communication modules and an embedded controller module. The one or more communication modules, for example, include a first communication module and a second communication module to communicate information related to each item contained in the movable object. The first communication module may include a first set of associated embedded firmware components and the second communication module may include a second set of associated embedded firmware components. Further, the second communication module is communicatively connected to the external controller. In addition, a third communication module is provided in the embedded system board to receive an input from a user of the apparatus. The third communication module is independent of the first and second communication module and is communicatively connected to the embedded controller module.

Further, the embedded system board includes the embedded controller module having a set of associated embedded firmware component communicatively connected to both the first communication module and the second communication module. In addition, the embedded controller module may include a memory unit. The memory unit is for storing information and status of each of the items and the movable object. A power supply module is also connected to the embedded system board to power up various embedded firmware components associated with the portable safety apparatus.

According to another embodiment of the present subject matter, the portable safety apparatus for securing the movable object and their associated items, as previously discussed, further includes a locking/unlocking unit (204). The locking/unlocking unit (204) is affixed in the housing and is operated by the embedded controller module. The locking/unlocking unit (204) operates a locking mechanism based on the embedded controller module receiving one or more control commands. The one or more control commands are a first command from the first communication module or a second command from the second communication module or a third command from the third communication module. The first command is communicated by a first communication protocol. The second and third commands are communicated by a second communication protocol and a third communication protocol respectively.

According to yet another embodiment of the present subject matter, a system for securing the movable object and associated items is disclosed. The system includes the movable object, a portable safety apparatus, and an external controller. The movable object includes a plurality of associated items. Each of the items comprises a unique identifier. The portable safety apparatus is configured to receive and transmit identification and status information, relating to each of the items associated with the movable object, from and to the external controller. In addition, the portable safety apparatus is configured to lock and unlock the movable object in response to the one or more control commands. The external controller includes a processor and a dedicated application. The processor is configured to process the identification and status information transmitted by the portable safety apparatus. The dedicated application is configured to issue the one more control commands to the portable safety apparatus based on the processed information.

These and other aspects of the present subject matter would be described in a greater detail in conjunction with the following figures. It should be noted that the description and figures merely illustrate the principles of the present subject matter. Further, the term ‘portable safety apparatus’ and the term ‘apparatus’ hereinafter may be used interchangeably.

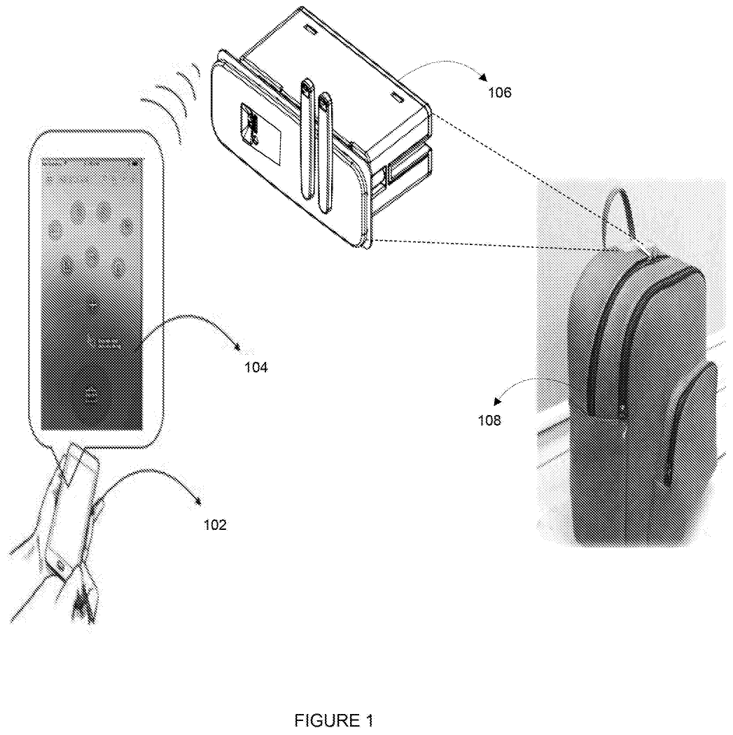

FIG. 1 illustrates a system for securing a movable object and associated items, in accordance with an embodiment of the present subject matter. The system (100) includes a movable object (108) containing a plurality of items. The movable object (108) may be, for example, a bag, a backpack, a suitcase, a briefcase, an organizer case, a purse, and the like. The movable object (108) is associated with a portable safety apparatus (106) and an external controller (102). The portable safety apparatus is also referred to as apparatus herein.

The apparatus (106) is to receive and transmit identification and status information from each of the items associated with the movable object (108), from and to an external controller (102). Further, the apparatus (106) is configured to lock and unlock the movable object (108) based on one or more control commands. The one or more control commands include a first command, a second command and a third command received by the apparatus in response to the transmitted identification and status information.

Each item associated with the movable object (108) includes a unique identifier. The unique identifier may be an RFID tag. The unique identifier may be affixed to each of the items. The items, for example, are keys, watches, wallets, purse, adapters, medicine containers, and the like. There are different types of unique identifiers, for example, battery assisted passive, active or passive. Active identifiers periodically transmit identification signals and have an on-board battery. In contrast, passive identifiers are devoid of batteries.

The unique identifiers, for example, may take the form of a sticker which can be printed on the surface of each item, or may take the form of a tag. According to an embodiment, the unique identifier takes the form of an RFID (radio frequency identification) tag. The unique identifier comprises a passive tag or an active tag or both. In an example, the RFID tag may be a low cost device of passive or active design that can be attached to one or more items to be tracked by a user. According to another embodiment, the tags may use NFC (Near Field Communication) or Infrared communication. As would be evident to one of ordinary skill in the art, the invention is not limited to the above exemplary communication means, and may include any type of communication means adapted to define a desired threshold range for detection of each item.

When an RFID tag is used as the unique identifier, the tag may operate on radio frequency (RF) signals, for example, in one or more of four common industrial, scientific, medical (ISM) frequency bands: 128 kilohertz, 13.56 megahertz, 915 megahertz, and 2.45 gigahertz.

The portable safety apparatus (106) may be affixed with the movable object (108) associated with the items desired to be tracked or monitored. List of items to be contained within the movable object (108) will be detected and recorded at a first instance by the portable safety apparatus (106) using the items' unique identifiers. The portable safety apparatus (106) that is associated with the movable object (108) is initially configured to be used with the unique detail of the external controller (102) that would be used to monitor the movable object (108) and the list of items associated with the movable object (108). Upon recording the list of items, the portable safety apparatus (106), after being configured to pair with the unique external controller (102), transmits the identifier of an item that is removed or replaced in the movable object (108), to the external controller (102).

Thus, every time one or more of the elements of the list of items associated with the movable object (108) is either moved out of the movable object (108) or moved into the movable object (108), it gets tracked by the portable safety apparatus (106) and communicated to the external controller (102). The external controller (102) utilizes a dedicated application (104) to monitor the list of items connected with the movable object (108). While the present subject matter is described with reference to an apparatus (106) of one movable object (108) communicating with the dedicated application (104) of the external controller (102), it will be understood that apparatuses of multiple movable objects, each including its set of associated items, can be connected to a single external controller (102) and managed through the dedicated application (104).

In one example, the dedicated application maintains the list of items associated with the movable object (108) and, based on the communication received from the apparatus (106), it flags status of each item as, for example, MISSING or IDENTIFIED depending on whether the item has been removed from the movable object (108) or is present in the movable object (108), respectively. In other examples, other methods of tracking the items, such as maintaining two separate lists of MISSING and IDENTIFIED items, may be used by the dedicated application to track the items based on the communication received from the apparatus (106).

The dedicated application (104) operating in the external controller (102) is thus enabled to list at any instance, based on the updates received when it was last in communication with the portable safety apparatus (106), if the list of items associated with the movable object (108) is in the category of being outside (MISSING) or inside (IDENTIFIED) the movable object (108). The external controller (102) may include a processor and the dedicated application (104) to process the identification and status information received from the portable safety apparatus (106), and generate the one or more control commands based on the processed information. The one or more control commands drive the portable safety apparatus (106) to lock and unlock the movable object (106).

Further, the user can customize the dedicated application (104) by assigning a suitable name to each of the items. Further, in order to ease the process of identifying the items, the user may associate images/ icons with the items, for example, from a database of the dedicated application (104). For example, if the item to be secured is a wallet, then the user may, after recording the item in the dedicated application (104), provide a name “my wallet” and assign a wallet symbol for the item. The items to be detected may range in size from a relatively small article, such as a product, package or box, to a relatively large article such as a pallet, crate or container. Accordingly, the movable object (108) may be a small bag or case or a large box or container.

Once the list of items is established and customized using the dedicated application (104) by the user of the external controller (102) for movable object (108) and once the portable safety apparatus (106) fitted on the movable object is configured, the user may actively monitor the presence of each of the items in the movable object (108) through the dedicated application (104). When any one of the items falls into the classification of the MISSING list a communication message is sent to the external controller (102) so that an alert may be issued to the user in a display of the external controller (102) so as to prevent loss or theft of the items which have fallen into the MISSING list and not brought into the IDENTIFIED list prior to locking the moving object (108). The alert may also include an alarm sound apart from a visual alert.

Thus, the external controller (102) may be configured to generate an alert from the portable safety apparatus (106) when at least one of the items is continuing to be in the MISSING list when the movable object (108) is put into the locked state. For example, an alert may include an audible tone, a visual indication, a kinesthetic buzzing or vibration indication, an e-mail message, a telephone call, and/or the like.

Further, an alert status lamp is also provided in the apparatus (106). The portable safety apparatus (106) fixed on the movable object (108) is pre-programmed during the configuration of the external controller (102) to monitor the status of items, such as IDENTIFIED or MISSING, and display an alert signal on the alert status lamp even in the absence of the external controller (102), when the lock is activated with at least one item associated with the movable object having the MISSING status. For this, the apparatus (106) can store the status of each of the items in a local memory, at least when the apparatus (106) is not connected to the external controller (102). Thus the apparatus (106) can locally indicate that at least one of the items from the list of the items is MISSING as recorded by the apparatus (106). The alert status lamp, for example, is a light emitting diode (LED). The system (100) is thus enabled for issuing a warning and ensuring safety of the items contained in the movable object (108) even in the absence of the external controller (102).

Further, a display of the external controller (102) may include any hardware suitable for presenting information to a user. The display, for example, includes a liquid crystal display (LCD) display operating with a touchscreen functionality. The display may also include icon representations and/or textual representations of the unique identifiers and their associated items. For example, the display may include an icon or symbol of a key, wallet, watch, and miscellaneous object. According to an embodiment, the display may include a representation indicative of whether the unique identifier associated with the items is in communication with the apparatus (106).

The portable safety apparatus (106) fitted on the movable object (108) may include one or more communication modules for detecting and/or communicating with unique identifiers of each of the items as well as communicate with the external controller (102). The external controller (102), through its dedicated application (104), indicates whether it is in communication with the apparatus (106). In other words, the external controller (102) determines whether the apparatus (106) is within the threshold detection range of the external controller (102). The threshold detection range of the apparatus (106) is variable depending on a monitored location and/or area in which items are to be detected. For example, the monitored location may be a larger area up to 30 feet away, or a smaller area up to 8 feet, or further smaller location of interest. Further, the apparatus (106) may communicate with the external controller (102) using any of a plurality of communication protocols. Furthermore, the external controller (102) may maintain a historical log of times and dates associated with communication between the external controller (102) and the apparatus (106). The historical log may provide a record of the location of the items at any instant of time. In this manner, the user of the external controller (102) is warned if the movable object (108) that was fitted with its own portable safety apparatus (106) is out of range of the external controller (102).

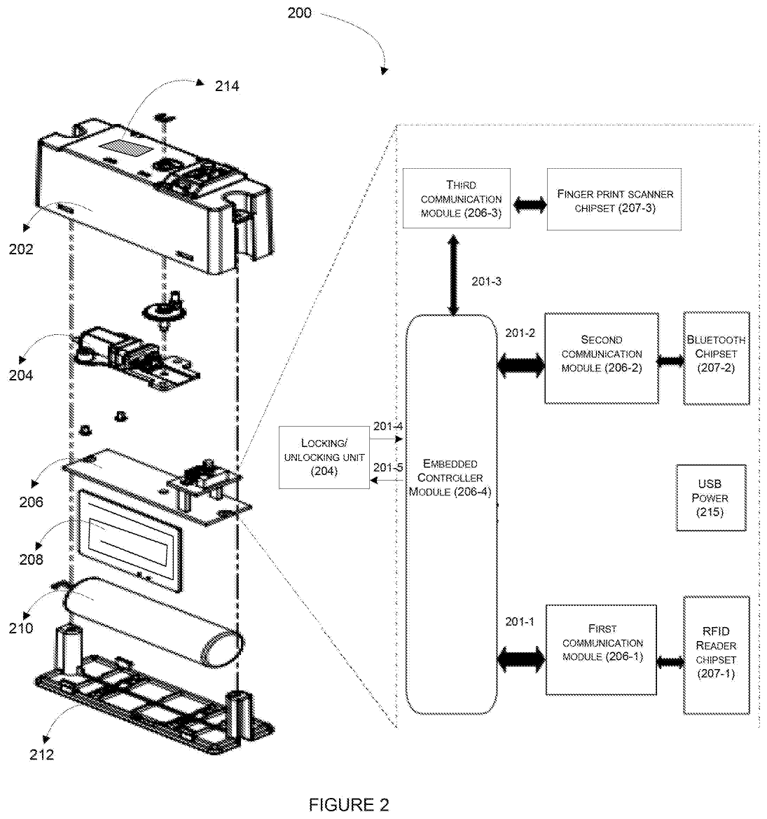

In an example, a user may program the external controller (102) with a plurality of customized forms presented by the dedicated application (104), where each form is associated with a movable object (108) and is stored in the database of the external controller (102). The customized form, for example, is a personal organizer or planner to create a list of items to be reminded to the user at regular intervals based on a predetermined interval specified by the user. The items to be included in the customized form may include, for example, a laptop to be reminded every morning, or reading glasses before leaving to the office. Furthermore, the dedicated application (104) may also be used at any point of security or at any place or on any other objects where the user may find it beneficial to have a reminder of items likely to be misplaced. The further description and FIG. 2 and onwards show how these functions are achieved.

FIG. 2 illustrates an exploded view of a portable safety apparatus (106) for securing the movable object and their associated items, in accordance with an embodiment of the present subject matter. The apparatus (106) in its implementation details is now referred as the apparatus (200) that may be affixed to the movable object (108) to be secured. The movable object (108), for example, is a bag, a luggage, a briefcase, and the like. In another example, the movable object (108) is a suitcase, garment bag, box, briefcase, or other item transported by an air carrier for a passenger.

The apparatus (200) includes a housing (202), a locking/unlocking unit (204), an embedded system board (206), an antenna (208), a power supply module in the form of a battery (210), and a base cover (212) of the housing (202). The housing (202) optionally comprises a finger print scanner (214) to receive a user input authentication for local lock/unlock commands.

The embedded system board (206) includes one or more communication modules, wherein the one or more communication modules is a first communication module (206-1) and a second communication module (206-2), and wherein the one or more communication modules communicate information related to each item contained in the movable object (108).

The embedded system board (206) further includes an embedded controller module (206-4) and its set of associated embedded firmware component communicatively connected to the one or more communication modules. The first communication module (206-1) is connected to a first set of associated embedded firmware components to communicate an identification information of each of the items associated with the movable object (108). The first set of associated embedded firmware components can be, for example, RFID reader chipsets (207-1). Each of the associated items in association with the movable object (108) includes a unique identifier, for example, an RFID label. The embedded system board (206) further includes a second communication module (206-2) and its second set of associated embedded firmware components to receive and transmit the identification information related to each of the items, from and to the external controller (102). The second set of associated embedded firmware components, can be, for example, Bluetooth chipsets (207-2).

The embedded controller module (206-4) is communicatively connected to the first and second communication module (206-1, 206-2). The embedded controller module (206-3) may include a memory unit for storing information related to the one or more items associated with the movable object (108). The embedded controller module (206-4) is further connected to a third communication module (206-3) that includes a third set of associated embedded firmware components. The third set of associated embedded firmware components, can be, for example, finger print scanner chipsets (207-3), which communicates with the finger print scanner (214).

The embedded controller module (206-4) further operates a locking/unlocking unit (204) for operating a locking mechanism based on one of a first command, a second command, and a third command received by the embedded controller module (206-4).

The first command is received by the first communication module (206-1) and associated chipset (207-1) from the antenna (208), which may be an RFID antenna in one example. Further, the embedded controller module (206-4) receives the first command from the first communication module (206-1) through a first communication protocol (201-1). The second command is received by the second communication module (206-2) and associated chipset (207-2) from the external controller 102. Further, the embedded controller module (206-4) receives the second command from the second communication module (206-2) through a second communication protocol (201-2). The third command is received by the third communication module (206-3) and associated chipset (207-3) from the finger print scanner 214. Further, the embedded controller module (206-4) receives the third command from the third communication module (206-3) through a third communication protocol (201-3).

In addition, a power supply module (210) is connected to the embedded system board (206). This embedded system board (206) includes a USB power port (215) as a provision to recharge the battery in the power supply module (210).

The first communication module (206-1) and the RFID reader chipsets (207-1) of the apparatus (200) are capable of sensing or detecting the presence of the items carrying the unique identifier, for example, the RFID tag. The first communication module (206-1), for example, is a RFID module (Radio Frequency Identification Modules) or a NFC module (Near Field Communication Modules). The RFID antenna (208) may be used for transmitting and receiving information related to one or more items in the movable object (108). The RFID antenna (208) may further include an integrated circuit for specialized tasks such as collection and processing the information relating to the one or more items.

According to an embodiment, information related to each item is detected by the first communication module (206-1) based on the RFID tag attached to each item and, at a first instance, the information detected is transmitted to the external controller (102). The external controller (102) includes a memory unit accessible by the dedicated application (104) to store the transmitted information from the apparatus (200). For example, the information detected is stored in the form of a list of items with a MISSING or IDENTIFIED flag for each of the items and corresponding RFID tag details.

According to another embodiment, the information detected may be stored in a local memory unit of the embedded controller module (206-4) in the form of the list of items, MISSING and IDENTIFIED flags for the items and corresponding RFID tag details in that listing. The embedded controller module (206-4) and its set of associated embedded firmware components, for example, are ultra-low power microprocessors, microcontrollers, field programmable gate arrays, digital logics and their like, comprising the local memory unit and a driver unit. The local memory unit may include an internal memory or a peer memory. The internal memory may be, for example, at least one of volatile memory (e.g., Dynamic RAM (DRAM), Static RAM (SRAM) or Synchronous Dynamic RAM (SDRAM)) or non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory or NOR flash memory).

According to an embodiment, the second communication module (206-2) may transmit the information stored in the local memory unit of the embedded controller module (206-4) to the external controller (102) so as to sync the MISSING and IDENTIFIED flags between the apparatus (200) and the external controller (102). The second communication module (206-2) and its second set of associated embedded firmware components, for example, is wireless MCUs (Master Control Units) operable with Bluetooth Smart, Zigbee, 6LoWPAN, Zigbee RF4CE, and their like. In the figure, Bluetooth chipsets (207-2) are illustrated as an example for the firmware components associated with the second communication module (206-2). The communication with the external controller (102) is scheduled to work through this second communication module (206-2) over the corresponding communication protocol.

In an example, the following control actions are executed by components of the embedded system board (206) within the associated apparatus (200). The first communication module (206-1), for example, a RFID transceiver reads information from a unique identifier, for example, a RFID tag of each item placed in/removed from the movable object (106), and transmits the read information through a first communication protocol (201-1) to the embedded controller module (206-4), for example, the microcontroller. The embedded controller module (206-4) upon receiving the information from the first communication module (206-1) may compare it with the status of the item (MISSING or IDENTIFIED) as stored in the local memory unit. In another implementation, the embedded controller module (206-4) may directly transmit the information to the external controller (102) without any processing.

The detection of the unique item by the RFID reader toggles the status of that unique item between MISSING and IDENTIFIED, for example, using status flags, in the memory of the external controller (102) and/or the embedded controller module (206-4). Effectively, if it was first associated with the MISSING flag, a detection will change it to the IDENTIFIED flag as the RFID tag detects the item within the zone of influence of the RFID antenna (208) in the apparatus (200). Conversely if the item was associated with the IDENTIFIED flag, a detection of the item by the RFID reader would change it to the MISSING flag.

The detection of the RFID tag happens in the zone of influence of the RFID antenna (208). Typically, no object would be in the zone or detected on a continuous basis with the apparatus (200) fitted near the mouth of the movable object as is illustrated in FIG. 1. So, the exposure to the detection zone of the RFID antenna (208) is limited to a physical area near the mouth of the bag. Thus, a detection of an item by the RFID antenna (208) would be indicative of the item having crossed the mouth of the bag, i.e., having been placed in or removed from the bag. Every time the IDENTIFIED and MISSING status is detected/ modified by a detection of an item by the RFID reader, the MISSING and IDENTIFIED status information relating to each item is then communicated to the external controller (102) through a second communication module (206-2) using a corresponding communication protocol, such as Bluetooth. The second communication module (206-2) is also used in configuring and pairing one or more the apparatus (200) with the external controller during the first configuration stage when the one or more apparatuses (200) fitted on each on the movable object (108).

The external controller (102), for example, is a computing device, a handheld device, a smart phone, and their like. The external controller (102) may maintain a historical log of times and dates associated with communication between the communication modules and the embedded controller module (206-4) of the apparatus (200). The historical log may provide a record of status (MISSING/IDENTIFIED) of the items at any instant of time. The external controller (102), for example, the smart phone may be associated with a plurality of apparatus (200), and in communication with each of the apparatus (200). A user of the external controller (102) may be required to download a dedicated application (104), for example, a smart-phone app or any other form, to access information recorded, received, processed, stored and transmitted by the communication modules of the embedded controller module (206-4). The external controller (102), for example, may also serve as an interrogator device and a control device by configuring it to perform a constant interrogation and periodic control for communication with the embedded controller module (206-4). The movable object (108) fitted with the apparatus (200) may be interrogated by the external controller (102) to retrieve information relating to their associated items to be secured, the information including the status of the lock/unlock status and the data containing the MISSING and IDENTIFIED items status as stored in the embedded controller module (206-4).

Further, the communication between the communication modules and the embedded controller module (206-4) is facilitated through one or more communication protocols. The first communication protocol (201-1), for example, is a Serial Peripheral Interface (SPI) bus communication. The second communication protocol (201-2), for example, is Universal Asynchronous Receiver/Transmitter (UART) bus communication. According to an embodiment, the embedded controller module (206-4) may be configured to use either of the communication protocols to transmit stored information from the local memory unit, however, it is conceivable to configure the embedded controller module (206-4) to transmit the stored information simultaneously using both communication protocols.

According to an embodiment, the first communication module (206-1), such as the RFID transceiver detects the presence of items within a threshold detection range. The detected information is then communicated as an information signal, like an interrupt, to the embedded controller module (206-4), using the first communication protocol (201-1), such as the SPI bus. The information signal, like an interrupt, is then processed to update the MISSING and IDENTIFIED statuses as already detailed. In one example, the updated statuses may also be stored in the local memory unit of the embedded controller module (206-4). The updated statuses are communicated to the second communication module (206-2), for example, a wireless Master Control Unit (MCU), such as a Bluetooth MCU, using the second communication protocol (201-2), such as the UART bus. The second communication module (206-2) further communicates the information signal to the external controller (102) using Bluetooth.

According to an embodiment, the embedded system board (206) may include a third communication module (206-3) and its third set of associated firmware components. The third communication module is communicatively connected with the finger print scanner (214), and the third set of associated firmware components are finger print scanner chipsets (207-3). The third communication module (206-3) is an independent module. For example, the third communication module (206-3) is not dependent on any control command from the external controller (102), or from the RFID reader chipset (207-1) interfaced to the embedded controller module (206-4). The third communication module (206-3), for example, is provided for enhanced security features overriding the first command and second command issued through the first communication module (206-1) and second communication module (206-2) respectively to activate/deactivate the lock. The finger print authentication may be linked to the pre-stored finger prints of users of the external controller (102) with the movable object (108).

Further, according to an embodiment, the local memory unit of the embedded controller module (206-4) is capable of storing information from the third communication module (206-4), for example, during installation. The information stored, for example, may be a fingerprint of an authorized user associated with the apparatus (200). In another example, the external controller (102) is used in a finger print acquisition mode so that the apparatus (200) would store the finger prints of the authorized user. The number of finger prints to be stored may be predefined, for example, to maximum of twenty at any instant.

Based on receipt of a locking/ unlocking trigger from the embedded controller module (206-4), the locking/unlocking unit (204) may operate a motor lock. In one example, the trigger may be generated by the embedded controller module (206-4) on receipt of a third command corresponding to detection of the finger print information of a user as an input on the finger print scanner (214) by the third communication module (206-3).

The embedded controller module (206-4) on receiving the input processed through the third communication module (206-3) and the finger print scanner chipsets (207-3) operates the motor lock. The user, for example, may swipe on the finger print scanner (214) to trigger an unlock operation, and swiped information may be compared by the embedded controller module (206-4) with the stored finger print information in the local memory unit. When the embedded controller module (206-3) detects a matching finger print information, it performs the unlock operation. Similarly, the user may perform a subsequent swipe to trigger the lock operation. The finger print swipe is thus a toggle arrangement for the lock/unlock status of the apparatus (200). The third communication module (206-3) and the embedded controller module (206-4) may communicate using a third communication protocol (201-3), for example, UART.

The motor lock is activated by communicating a trigger signal (201-4) to perform a lock or an unlock operation by the embedded controller module (206-4). The trigger signal (201-4) is initiated based on the control commands received from either the finger print scanner (214) or the external controller (102) or a RFID master key. The motor lock, on performing either the lock or an unlock operation, may communicate a status signal (201-5) to the embedded controller module (206-4) indicating the status of the apparatus (200) with respect to the movable object (108). For example, the motor lock may optionally include a micro switch. An on/off status of the micro switch is communicated as a status signal (201-5) to the embedded controller module (206-4) in response to the trigger signal (201-4).

According to another embodiment, a fourth communication module may be provided as a Wi-Fi module (not shown in the figures). The Wi-Fi module and its associated embedded firmware components may be placed on the same embedded system board (206). The Wi-Fi module may be used in lie or in addition to the second communication module to communicate the information signal to the external controller (102). According to another embodiment, the embedded system board (206) further includes a position detection module and its associated embedded firmware component. The position detection module is one of a GPRS (General Packet Radio Service) module and a global system for mobile communication (GSM) module. GPRS uses a packet-based wireless communication technology to transfer high and low speed data and signaling in an efficient manner. GPRS optimizes the use of network and radio resources, thus enabling the cost effective and efficient use of GSM network resources for packet mode applications. The references to GSM are not exclusive, however, as it should be appreciated that embodiments may be implemented in connection with any type of wireless access system such as, for example, CDMA or the like.

The embedded system board (206) as depicted in FIG. 1 is, for example, a printed circuit board (PCB) affixed to the housing (202) of the apparatus (200), which includes mechanically supporting and electrically connecting components.

According to an embodiment, the embedded system board (206) may also support one or more sensors, for example, g-sensors or accelerometer, configured to disable or enable transmitting capabilities respectively during motion, for example, take-off, taxiing and landing of an airplane, movement in a car or due to walking, etc. These sensors may also be configured to recognize movement of the movable object (108) for a predefined period of time and automatically communicates a control signal to switch the apparatus (200) from “active or online mode” to “passive or sleep mode”, and vice-versa. A power supply unit (210) and a USB power (215) is provided within the apparatus (200) to power up various components of the apparatus (200). The power supply unit (210), for example, is a battery and may further include provisions for power management and recharge. The battery, for example is a 5000 mAh Li-ion Battery, recharged using a USB (Universal Serial Bus) port. According to another embodiment, the apparatus (200) includes an array of light emitting diodes operable to emit light in response to actuation of the movable object (108) detected by means of one or more sensors, for example, a rotational position sensor or a linear position sensor.

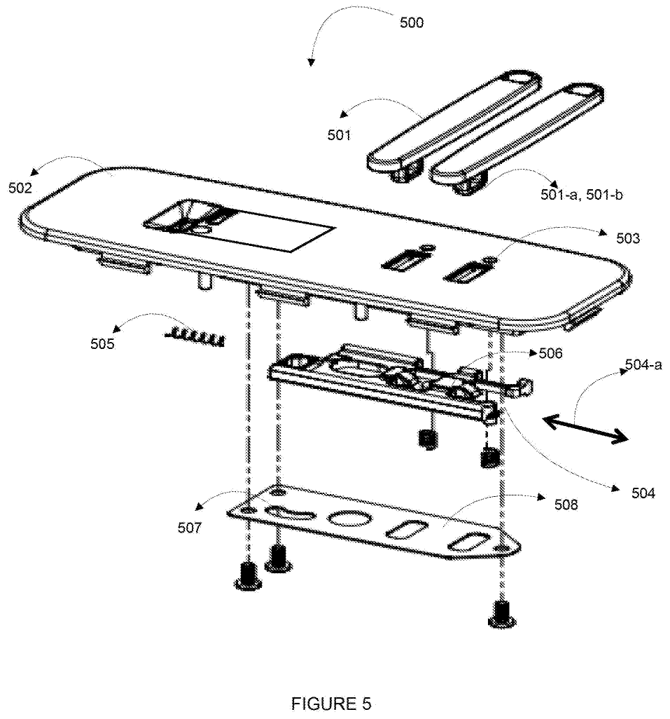

As discussed previously, the one or more commands for triggering a lock and unlock operation may include the first command, which is based on a dedicated identifier identified by the first communication module (206-1). The first command is independent of the second command, and the dedicated identifier is, for example, a RFID Master Key. The master RFID is designated as master during the configuration process discussed and detailed later in this specification. The detection of the RFID master key by the RFID reader issues the trigger command through the first communication module (206-1), which in turn communicates to the embedded controller module (206-4) to drive the locking/unlocking unit (204). Further, the one or more commands for triggering a lock and unlock operation may include the second command, which is based on a user command form a dedicated application (104) running in the external controller (102), for example, Android and IOS applications, of the external controller (102). The external controller (102) is equipped with wireless communication module, such as Bluetooth module, in order to issue the second command to the second communication module (206-2), which in turn communicates it to the embedded controller module (206-4) to drive the locking/unlocking unit (204). The apparatus (200) further includes dedicated pins in the embedded controller module (206-4) for connecting to a motor of the locking/unlocking unit (204) and the dedicated pins are exited for a predetermined period as suitable for the motor operation time to move the locking mechanism cam described later in this specification. The predetermined period, for example, ranges from about 800 to about 1200 milliseconds. The various components and the operation of the locking/unlocking unit (204) are explained in detail in conjunction with FIG. 5. Further, an information regarding an actuation of the locking/unlocking unit (204) is recorded to determine when the locking/unlocking unit (204) was last actuated or when an attempt was made to actuate the locking/unlocking unit (204). The actuation information along with the status signal (201-4) may be recorded in the local memory unit of the embedded controller module (206-4) and/or transmitted to the external controller (102). The status signal (201-4) includes the current status, for example, on and off status of the micro switch, indicating whether the motor lock is locked or unlocked. When the user of the external controller (102) is notified of the information relating to the event of actuation or attempted actuation, and the status, the user may promptly check the presence of all the items in the movable object (108) by interrogating the apparatus (200) and syncing the external controller though the second communication module (206-2) with the status of the embedded controller (206-4) data that includes the lock/unlock status and the MISSING and the IDENTIFIED status.

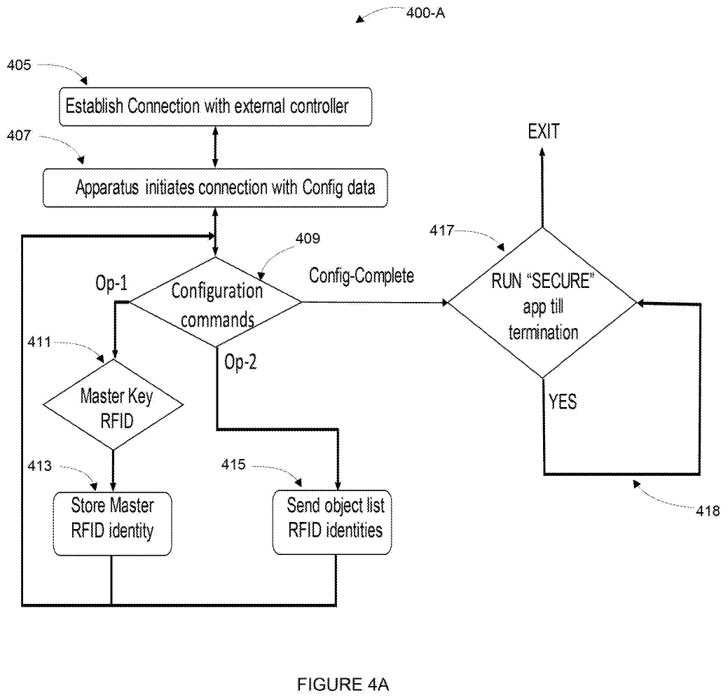

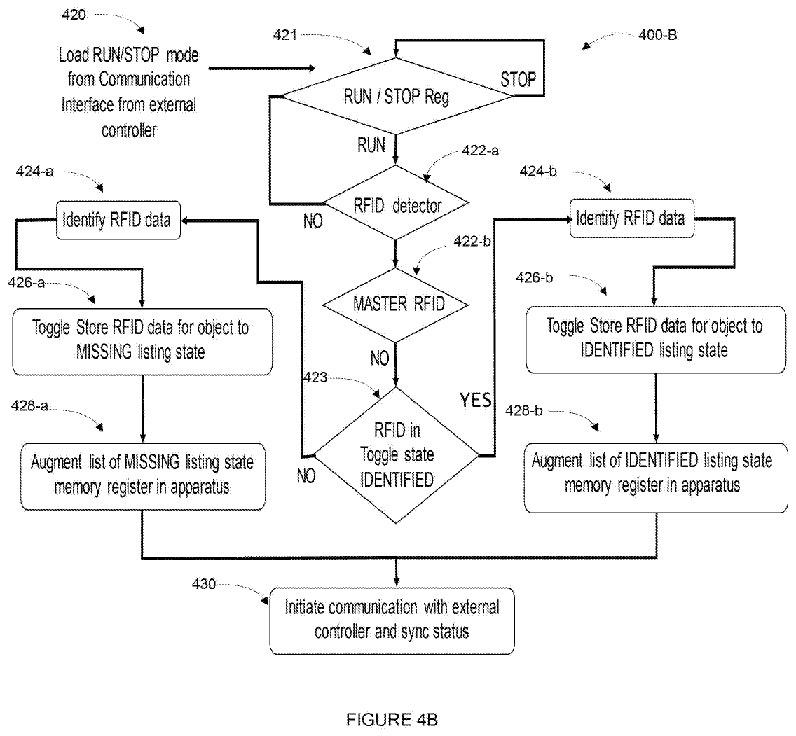

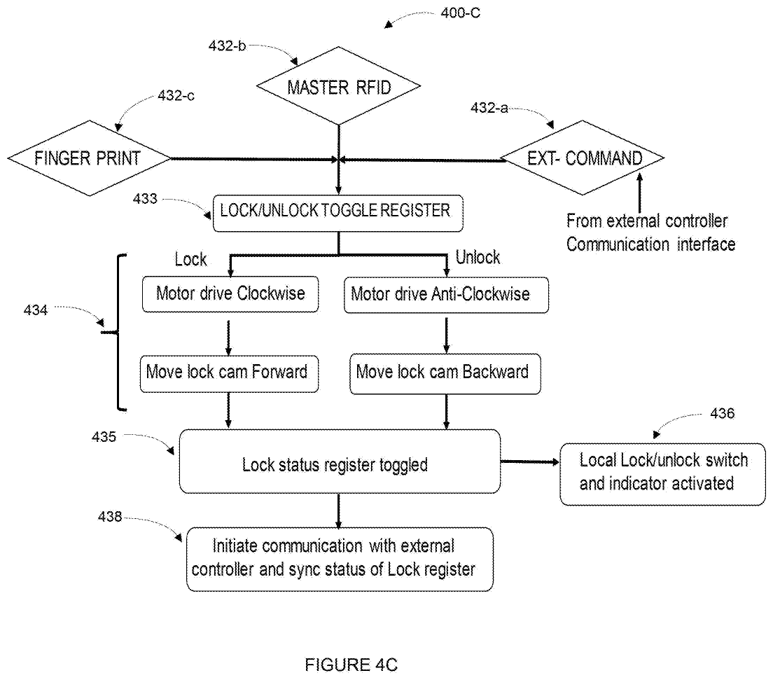

In an example, even when a connectivity between the apparatus (200) and the external controller (102) is lost, then, at the event of a lock or unlock operation, the embedded controller module (206-4) may communicate a control signal to activate a local status lamp in response to the received status signal (201-4). The local status lamp may indicate whether a lock operation or an unlock operation had occurred even in the absence of the external controller (102). The embedded controller module (206-4) may be pre-programmed to transmit the control signal to activate the local status lamp at the event of locking and unlocking operation or in the absence of connectivity with the external controller (102) through the configuration process later detailed in this specification with respect to FIG. 4A.

According to an embodiment, when the apparatus (200) is in the “online mode”, i.e., in communication with the external controller 102, the embedded controller module (206-4) may be configured to periodically transmit status information via second communication module (206-2) to the external controller (102). In the absence of the external controller (102), within the threshold detection range of the apparatus (200), the embedded controller module (206-4) stores the status information and all recorded events relating to the actuation of the motor lock for a later transmission when the external controller (102) is found within the threshold detection range for communication. The status information may include the last recorded locking status i.e. “locked” or “unlocked” as detected by the embedded controller module (206-4) using one or more sensors, such as the micro switch, and the recorded events may include change in status of one or more items of the movable object (108).

Further, according to an embodiment, the dedicated application (104) of the external controller (102) may be configured to automatically query the apparatus (200) at a predefined interval as determined by the user in order to determine the status information. For example, if a user wishes to determine the locking status of a luggage, the user may instruct the dedicated application (104) to transmit a query message from the smartphone to locking apparatus over wireless networks such as Bluetooth frequencies or GSM network, where available. The second communication module (206-2), for example, the wireless Master Control Unit of the apparatus (200) receives the query message for processing by the embedded controller module (206-4) and transmits a response message with status information to the external controller (102). In addition, the embedded controller module (206-4) is configured to transmit status information to the external controller (102) immediately upon detection of a locking event or unlocking event or any actuation event so that the user is alerted to the event.

Further, the term “module” as used herein may include its ordinary meaning including, but not limited to, for example, a unit of one, or a combination of two or more, hardware, software or firmware. The term “module” may be used interchangeably with terms such as, for example, unit, logic, logical block, component or circuit. A module may be the smallest unit for performing one or more functions, or a portion thereof. A module may be implemented mechanically, or electronically. For example, a module according to the present disclosure may include at least one of a known, or to-be-developed, Application-Specific Integrated Circuit (ASIC) chip, Field-Programmable Gate Array (FPGA) or programmable logic device that perform certain operations.

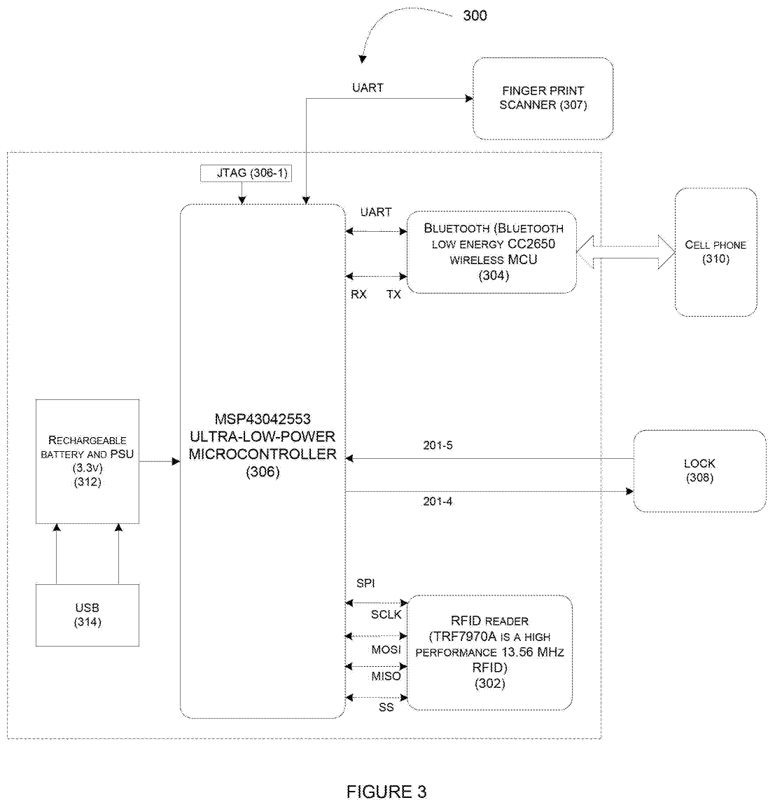

FIG. 3 illustrates an example implementation of an embedded system board of the portable safety apparatus of FIG. 2 in communication with an external controller, in accordance with an embodiment of the present subject matter. The below-described example operating environments should be considered non-exhaustive, however, and thus the below-described network communication architecture merely shows an example network communication architecture in which aspects of various embodiments may be incorporated. One can appreciate, however, that aspects of the embodiment may be incorporated into now existing or future alternative architectures for communication networks.

The block diagram (300) represents one exemplary implementation of an embedded system board (206) comprising an embedded controller module (206-4) in the form of MSP430G2553 ultra-low-power microcontroller (306) along with a first communication module (206-1) in the form of TRF7970A RFID transceiver (302), which is a high performance 13.56-mhz HF RFID and NFC transceiver IC composed of an integrated analog front end (AFE). The ultra-low-power microcontroller (306) will also be interfaced with a second communication module (206-2) in the form of Bluetooth low energy CC2650 wireless MCU Bluetooth controller (304). A locking/unlocking unit (204) comprises an electromechanical lock, for example, a motor lock (308), interfaced with the ultra-low-power microcontroller (306) and operated based on a first command and a second command issued by a master RFID tag and a Bluetooth command respectively.

A status signal (201-5) is provided back from the motor lock (308) to the embedded controller module (206-4) in response to the trigger signal (201-4). The status signal (201-5) indicating whether the lock is in the status locked or unlocked physically and indicated by a suitable micro switch provided into the locking mechanism and activated to on or off status depending on the lock condition. A local status lamp indicates locally the lock status as locked or unlocked based on the micro switch on/off status.

The embedded system board (206) will perform the lock and unlock function when the RFID master key/tag is scanned or according to the command received through Bluetooth from the mobile application or according to the command received from the Finger Print Scanner (307). Also, the embedded system board (206) will transfer the information of scanned RFID tag of plurality of items associated with a movable object (108) to a mobile application of the user through Bluetooth. The transferred data may be updated and stored in the mobile application database.

The MSP430G2553 (306) communicates RFID tag details which are read with the help of the TRF7970A (302) to the CC2650 (304) by means of UART communication protocol. The CC2650 (304) notifies those details to an external controller (102), represented as mobile phone (310), of the user through which the user can organize the plurality of items contained in the movable object (106). Also, a control command from the mobile phone (310) to lock or unlock the movable object (106) is communicated to the CC2650 (304) through mobile application which in turn is communicated to the MSP430G2553 (306) by means of UART communication protocol. MSP430G2553 (306) performs the lock or unlock function according to the control command it has received.

Lock/unlock functionality is implemented by a driving unit of the MSP430G2553 (306), which drives a motor of the motor lock (308) back and forth with the help of MSP430G2553 GPIO pins. GPIO pins connected to the motor are made high and low for time in the range of 1000 ms to 1200 ms. In other words, 1000 ms to 1200 ms is the excitation time required for the motor to rotate its shaft so that lock cam moves from its one end to another for locking/unlocking the movable object when the lock/unlock control command is sent by the user through mobile application or when the RF Master Key is scanned by the TRF7970A (302). The master key is separately provided to the user along with other RFID item tags. Whenever the lock functionality is performed, a status of the lock, indicating whether the motor lock (308) is locked or unlocked is stored in the flash memory of MSP430G2553 (306). The mobile application of the user may then check the status of the lock by querying the flash memory of the MSP430G2553 (306) every time the user wants to perform the lock/unlock function.

RFID item tags provided along with the movable object (106), for example, a set of bags, may be used by the user to recognize the items needed to carry in the respective bags. The RFID item tags are scanned by the TRF7970A (302) each time when the item having the tag is either being placed into the respective bag or is being removed from the respective bag. Also, the TRF7970A (302) may be configured to poll the RFID tags at predetermined time intervals, say every 350 ms. The RFID tag then transmits the UID (unique identifier) and its associated RSSI (Received Signal Strength Indication) values.

The transmitted information is then communicated to the MSP430G2553 (306) by means of a first communication protocol (201-1) in the form of (Serial Port Interface) SPI communication protocol. The RFID tag information is then communicated to the user's mobile (310), or stored in the flash memory of the MSP430G2553 (306) depending upon the connectivity between the apparatus (200) and user's mobile (310). If there is a communication between the apparatus (200) and the user's mobile (310), the tag details are communicated through the CC2650 (304) to the user's mobile (310) else, the scanned information are stored in the flash memory of the MSP430G2553 (306). When the connection is established subsequently, the user's mobile is updated with the scanned details by fetching it from the flash memory of the MSP430G2553 (306).

CC2650 (304) communicates with MSP430G2553 (306) through UART about its connection status with the user's mobile (310). The connection status indicates two modes, such as an advertising mode and a communicating mode. MSP430G2553 (306) stores RFID tag details in the flash memory when the CC2650 (304) indicates advertising mode and communicates RFID tag details along with locking/unlocking status when CC2650 (304) indicates communication mode.

Further, in the example, the MSP430G2553 (306) may be programmed to continuously send commands to the TRF7970A (302) and to set its registers to read the RFID tags, and also check for the connection status with the CC2650 (304). The MSP430G2553 (306) may also read the voltage level of power supply with the help of inbuilt ADC converter.

In the example, RFID tags designed with the protocol ISO15693 (I-Code) are used as unique identifiers to be affixed with the plurality of items in the bag. The TRF7970A (302) may be configured to read the same protocol tags. Each time an RFID tag is scanned, the TRF7970A (302) determines whether the scanned tag is a master key. Once the master key is detected by the TRF7970A (302), lock/unlock functionality is performed. When it is determined that the tag is not a master key, then a connection status with the CC2650 (304) is checked and the RFID tag details are either stored in the MSP430G2553 (306) or communicated to CC2650 (304) accordingly.

The MSP430G2553 device (306), which is used as the embedded controller module (206-4), comprises a digital controlled oscillator calibrated for 8 MHZ. Further, GPIO pin 2.0 of the MSP430G2553 (306) is connected to the IRQ pin of TRF7970A (302) which is utilized to give the interrupts whenever the data transfer is done through Serial Port Interface Protocol. Pin 2.2 is connected to the enable pin of TRF7970A (302) which is used to enable or disable the apparatus. Pin 2.1 is used as slave select pin and pins 1.5, 1.6 and 1.7 are used for clock, MISO (Master In Slave Out) and MOSI (Master Out Slave In) of SPI communication respectively. Pins 1.1 and 1.2 are used as RX (receiver) and TX (transmitter) pins of UART communication. Pins 1.3 and 1.4 are configured for driving the LEDs (Light Emitting Diodes) whereas pins 3.5 and 3.6 are configured for driving the motor of the motor lock. In addition, the MSP430G2553 device (306) includes a JTAG (306-1) communication port used for a debugging, programming, and testing interface typically found on microcontrollers, ASICs, and FPGAs. It enables all components to be tested, programmed, and/or debugged using a single connector on a PC board.

The TRF7970A (302) device is a high performance 13.56-MHz HF RFID and NFC Transceiver IC composed of an integrated analog front end (AFE) and a built-in data framing engine for ISO15693. This includes data rates up to 848 kbps for ISO14443 with all framing and synchronization tasks on board (in default mode). The TRF7970A (302) also supports NFC Tag Type 1, 2, 3, and 4 operations. This TRF7970A (302) is used for RFID communication at the frequency 13.56 MHz.

The CC2650 device (304) is a wireless MCU targeting Bluetooth Smart, ZigBee® and 6LoWPAN, and ZigBee RF4CE remote control applications. The device is a member of the CC26xx family of cost-effective, ultralow power, 2.4-GHz RF devices. The CC2650 device (304) contains a 32-bit ARM Cortex-M3 processor that runs at 48 MHz as a main processor and includes an ultralow power sensor controller. This sensor controller is ideal for interfacing external sensors and for collecting analog and digital data autonomously while the rest of the system is in sleep mode. Thus, the CC2650 device (304) is ideal for applications within a whole range of products including industrial, consumer electronics, and medical. The Bluetooth Low Energy controller and the IEEE 802.15.4 MAC are embedded into ROM (read only memory) and are partly running on a separate ARM Cortex-M0 processor.

Further, in the apparatus discussed in the above example may include a Fingerprint Scanner (307), for example, GT-511C1R. The fingerprint scanner (307) supports all microcontrollers, microprocessors android/iOS and like operating systems, providing privileges to use open source compatible module for custom (Android/iOS) integration. More precisely, it provides a high-speed, high-accurate fingerprint identification using the Smack Finger 3.0 Algorithm. It provides a 32-bit CPU at 72 MHz (ARM Cortex M3) and a database which can store up to 20 different fingerprints. It can recognize a fingerprint in whatever 360° position. Downloads and uploads of fingerprint scans can be done by using the serial interface. The finger print scanner may work with UART (Universal Asynchronous Receiver/Transmitter) communication based on an UART communication protocol interfaced through a serial cable with microcontroller.

Further, the external controller (102), for example, the mobile phone (310), is configured with a dedicated application (104), a dialog box will pop up for turning on the Bluetooth will be appear as soon as the application is launched. Once, a command for turning on the Bluetooth is provided by the user, the dedicated application may automatically detect whether any Bluetooth device/apparatus is available or not within a threshold range. In the example, the threshold range may be about 10 mtrs to 15 mtrs. In addition, a “scan” button may be provided, once the button is pressed, a list of detected Bluetooth devices will appear in the display of the user's mobile. Once, the desired Bluetooth device is selected, the status and other information of the device will be shown and all control options will become active. The user by selecting the desired control options may initiate a query command to fetch information about the plurality of items in proximity to the Bluetooth device or a control command to control the locking and unlocking of the movable object. The dedicated application (104) may interrogate more than one Bluetooth device at any time. The pairing of the external controller (102) and the apparatus (106) is made secure by the use of a second identity for the external controller, for example if the external controller is a mobile smart phone the identity is the IMEA number, and second identity of the embedded controller module (206-4) being the MAC (Media Access Controller) number of the embedded controller module (206-4).

FIG. 4A illustrates a flowchart for establishing a secure connection between the external controller and the portable safety apparatus of FIG. 2, and configuring the portable safety apparatus (200) in accordance with an embodiment of the present subject matter. The configuring of the apparatus (200) is based on the authentication of a first and a second identity information

The order in which the method blocks are described in the flowchart is not included to be construed as a limitation, and some of the described method blocks can be combined in any order to implement the method 400-A, or an alternative method. Additionally, some of the individual blocks may be deleted from the method 400-A without departing from the scope of the subject matter described herein.

FIG. 4A depicts an example system configuration protocol (400-A) for the apparatus (200) in communication with an external controller (102). In the FIG. 4A, a method for establishing a connection between an external controller (102) and the apparatus (200) is illustrated. At step 405, the portable safety apparatus (200) establishes a communication link with the external controller (102) through one or more communication protocols, for example, wireless, Bluetooth or USB based protocol. Once the communication link is established, then at step 407, the apparatus (200) communicates a first identity information to the external controller (200) by sending a first identity of the embedded controller (206-4) in the portable apparatus (200) to the external controller (102). This is followed by receiving a second identity of the external controller (102) from the external controller (102) by the embedded controller (206-4) through the communication protocol. The configuring of the apparatus (200) is based on the authentication of the first and second identity information. The identify information, for example, is the MAC address of an embedded controller (206-4) in the apparatus (200). This MAC address is unique to the embedded controller (206-4). Therefore, such identity information makes it feasible for a single external controller (102) to link with multiple apparatus (200), each having a unique MAC address. For example, when an information packet is communicated from the apparatus (200), a header data of the information packet may include the identity information. The external controller on receiving the information packet and on checking the header data may become operational, and the apparatus (200) begins broadcasting status information regarding one or more items associated with it by way of the data connected with the lock/unlock status and the contents of the IDENTIFIED and MISSING list.

Further, at step 407, the apparatus (200), the external controller (102) may communicate a second identity information to the apparatus (200). The identify information, for example, is an IMEA number of a smart phone. For example, when an information packet is communicated from the external controller (102), a header data of the information packet may include the identity information. The apparatus (200) on receiving the information packet and on checking the header data may become operational, and the apparatus (200) begins broadcasting status information regarding one or more items associated with it.

The configuration of the apparatus (200) may be based on the first and second identity information.

Once the configuration data such as the identity information are programmed and communicated with the apparatus (200) and the external controller (102), at step (409), a decision block is executed in relation the configured data for handling the RFID tags. The apparatus (200) in its operational state may read a RFID tag, and determines whether it matches the configured data. At step 411, if the RFID tag read by the apparatus is determined to be a Master RFID key based on the configured data, then at step (413), the master RFID key is stored in a local memory unit of the apparatus (200) and the necessary action connected with the master RFID tag like the lock/unlock actuation may be performed. At step 409, if the RFID tag read is a tag other than the Master RFID key, then the RFID tag details is stored in the form of list (415) in the local memory unit for populating the MISSING or SECURE listing when objects attached to the RFID tag which is not a master RFID tag or is transmitted to the external controller (102), which stores the RFID tag in its memory unit. At step (409), the commands shown as Op-1 and Op-2 from the external controller application (104) are user based commands as part of the configuration protocol and the command Config-Complete moves the communication protocol to step 417, from where the external controller (102) may be activated to run the control application of the apparatus (106) to secure the items in the movable object, and control application once initiated runs into an endless loop operation till terminated to an EXIT canceling the application (104) in the external controller (104).

The configuration data thus stored in the local memory unit is a part of the non-volatile memory embedded controller module (206) earlier explained in FIG. 3 that operates in the apparatus (200) and the date is synced with the external controller (102). All communications between the apparatus (200) and the external controller (102) may be two-way communications.

FIG. 4B illustrates a working of the portable safety apparatus of FIG. 2 in response to a dedicated application of the external controller, in accordance with an embodiment of the present subject matte. In the Figure, the method for detecting one or more items and their RFID unique identifiers associated with one or more items associated with the movable objects (108) is shown. At step 420, external controller (102) issues either a RUN or a STOP command to operate the apparatus (200) either in the RUN or STOP mode. The functionality begins after receiving a RUN command form the external controller. The core functionality of activating a RFID detector to detect one or more items and their unique identifiers is based on the RUN command. In an implementation illustrated in FIG. 4B, the apparatus (200) continues to be in the set RUN/STOP mode at the last communication protocol initiated by the application (104). In effect if after setting the apparatus to RUN mode, the external controller is disconnected from the apparatus (200), the apparatus would remain in the RUN mode. The STOP mode is a selection which can disable the apparatus (200) if needed from the external controller (102) and in this STOP mode the apparatus is moved to the unlock position till a RUN command is set. This logical state is achieved at step 421. At step 421, if it is determined that the register is in the STOP mode, the method steps for system configuration as depicted in FIG. 4A is executed and the operation of the embedded controller module (206-4) is halted for reading the RFID tags and the only operations feasible are the lock/unlock operation using the finger print identified protocol later explained with respect to FIG. 4C. However, if at step 421, if it is determined that the register is in the RUN mode, then at step 422-a, a first communication module (206-1) in the form of a RFID reader/detector is turned ON based on the RUN command to detect one or more items and its unique identifiers from the RFID reader output. For example, the RFID tags of each item are detected. At step 422-b, the core function of the embedded controller (104) determines if the detected RFID tag is a Master RFID tag or a non-Master RFID tag. A further decision loop is executed at step 423, the result of which stores the detected RFID tag either in a IDENTIFIED listing or in a MISSING listing In case the detected RFID tag is not a master tag, the core function ensures that when the unique identifier matching the configured data stored in the apparatus (200) is in the affirmative then, the core function toggles the item detected to an IDENTIFIED list if already in the MISSING listing and toggles the item detected to the MISSING list if already in the IDENTIFIED list. This core functionality is achieved at step 423, when the RFID tag associated with the item is detected as a configured RFID tag is in the IDENTIFIED listing, then at step 424, the data or the information relating to such item is identified and stored or added at step 426-a to the MISSING listing state. For example, under initialized condition the RFID listing state of each of the configured items in the listing is listed as MISSING state and the list of all such objects to be in the list and identified as first MISSING is appended to the MISSING list. To enable this core function post configuration, at the end of the configuration illustrated in FIG. 400-a, all items are listed as MISSING and then the RFID assisted toggling the items between the MISSING and IDENTIFIED listing is performed.

Each of the items after performing the configuration can be pushed into the threshold detectable range of the RFID detector, the detection of the pre-configured RFID tag of the items results in the items being moved from the MISSING list to the IDENTIFIED listing. The process to be executed if the RFID detector at step 422-b detects a Master RFID tag is explained in details in the flowchart of FIG. 4C. Further, at step 423, when the RFID detector determines that a RFID tag pre-configured, then the data or information relating to such RFID tags are identified at step 424, and stored in the IDENTIFIED listing state. Further, at step 428-a, and 428-b, the list under the MISSING or IDENTIFIED listing is stored in the local memory unit of the apparatus (200). At step 430, a communication interface is established with the external controller (102), in order to sync a status register of the external controller (102) by updating the MISSING and IDENTIFIED listing.

The communication interface is duplex in nature so that the data transmission in the interface is dual directional. This ensures that the external controller (102) with every instance of a transmission from the apparatus (200) illustrated in 400-B gets updated with the status register containing the MISSING and IDENTIFIED list and the communication from the external controller (102) ensures that the RUN/STOP register is loaded with either the RUN command or the STOP command.

FIG. 4C illustrates a locking/unlocking mechanism of the portable safety apparatus of FIG. 2 enabled from one or more control commands, in accordance with an embodiment of the present subject matter. This procedure determines whether the unique identifier detected is a Master RFID wherein when the detected unique identifier is a Master RFID, performing one of the lock and unlock operations. At step 432-a, an RFID master key detected at step 422-b, is used for sending a first command to a locking/unlocking unit (204) of the apparatus (200) through an embedded controller module (206-4). At step 433, a lock/unlock toggle register is triggered based on the first command. At step 432-b, an external controller issues a second command to a locking/unlocking unit (204) of the apparatus (200) through the embedded controller module (206-4). At step 433, the lock/unlock toggle register is triggered based on the second command. At step 432-c, a finger print scanner (214) issues a third command to a locking/unlocking unit (204) of the apparatus (200) through the embedded controller module (206-4). At step 433, the lock/unlock toggle register is triggered based on the third command. The first, second, and third commands may be either a lock or an unlock command individually. For example, the lock can be activated with one of the three commands and the unlocking can be carried out by any other of the three commands. If at step, 433, it is determined that the command is a lock command, then at step 434, a motor drive of the locking/unlocking unit (204) rotates clockwise and a motor lock cam is moved forward. If at step, 433, it is determined that the command is an unlock command, then at step 434, a motor drive of the locking/unlocking unit (204) rotates ant-clockwise and a motor lock cam is moved in reverse. Therefore, a rotary mechanism of the motor drive is converted by the motor lock cam into linear forward and reverse movements. At step 434, a micro-switch is also activated in response to the locking and unlocking operation. At step 435, the lock/unlock toggle register is toggled based on current status. At 436, in response to the activation of the micro-switch and the toggling at step 435 a local status indicator/lamp is activated. Further, at step 438, a communication interface is established with the external controller (102) and the status of the lock/unlock toggle register is synced.

The method of the present invention can be realized in hardware, software, or a combination of hardware and software. An implementation of the method and system of the present invention can be realized in a centralized fashion in one computer system, or in a distributed fashion where different elements and different external controllers are spread across several interconnected computer systems and status and operation can be controlled in a centralized manner. Any kind of computer system, or other apparatus adapted for carrying out the methods described herein, is suited to perform the functions described herein. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods

FIG. 5 is an exploded view of a locking/unlocking unit of the portable safety apparatus of FIG. 2, in accordance with an embodiment of the present subject matter. The locking mechanism (500) is achieved through the linear movement of the motor lock cam (504) by operating it in the forward and reverse axis (504-a). The motor lock cam (504) contains in its geometry a pair of lock hooks (506) that are complementary to the hole (501-a and 501-b) in zip locker pull tags (501) of a movable object (108) that fit into the slots (503) of the apparatus (200). The cam (504) is loaded to move into a preferential direction of unlocking through the tension spring (505). A guide plate (508) is fitted to the cover (502) so that the cam (504) is held in position and a curved slot (507) ensures that the cam pin of the motor lock projects through the plate (508) to move the cam (504) in the forwards and reverse directions (504-a) to lock and unlock the zip locker pull tags (501).

In yet another embodiment, the motor lock when either actuated in a forward or backward direction using the locking mechanism makes a contact with a micro switch (not shown in figure), and the micro switch is snapped either to an on or off status based on the locking or unlocking action. The micro switch further sends a status signal indicating the on/off status to the embedded controller module

Although implementations of present subject matter have been described in language specific to structural features and/or methods, it is to be understood that the present subject matter is not necessarily limited to the specific features or methods described. Rather, the specific features and methods are disclosed and explained in the context of a few example implementations of the above-mentioned aspects of the present subject matter.

I/We claim:

1. A portable safety apparatus (200) for securing a movable object (108) and its associated items comprising:
a housing (202);
an embedded system board (206) fixed in the housing (202), wherein the embedded system board (206) comprising:
one or more communication modules, wherein the one or more communication modules is a first communication module (206-1) and a second communication module (206-2), and wherein the one or more communication modules communicate information related to each item contained in the movable object (108);
an embedded controller module (206-4) comprising associated embedded firmware component, the embedded controller module (206-4) being communicatively connected to the one or more communication modules; and
a locking/unlocking unit (204) operating a locking mechanism based on one of a first command, a second command, and a third command received by the embedded controller module (206-4) from the one or more communication modules; and
a power supply module (210) connected to the embedded system board (206).

2. The portable safety apparatus (200) as claimed in claim 1, wherein the first communication module (206-1) includes a first set of associated embedded firmware components and the second communication module (206-2) includes a second set of associated embedded firmware components.

3. The portable safety apparatus (200) as claimed in claim 1, wherein the embedded system board (206) further comprises a third communication module (206-3) to receive an input from a user of the apparatus (200), wherein the third communication module (206-3) is independent of the first and second communication module (206-1, 206-2) and is communicatively connected to the embedded controller module (206-4).

4. The portable safety apparatus (200) as claimed in claim 1, wherein the first communication module (206-1) and its first set of associated embedded firmware components communicates an identification information of each of the items associated with the movable object (108) to an external controller (102).

5. The portable safety apparatus (200) as claimed in claim 1, wherein the second communication module (206-2) and its second set of associated embedded firmware components are configured to receive and transmit the identification information related to each of the items, from and to the external controller (102).

6. The portable safety apparatus (200) as claimed in claim 4, wherein the first set of associated embedded firmware components includes an RFID reader chipset (207-1).

7. The portable safety apparatus (200) as claimed in claim 5, wherein the second set of associated embedded firmware component includes a Bluetooth chipset (207-2).

8. The portable safety apparatus (200) as claimed in claim 3, wherein the third communication module (206-3) includes a third set of associated embedded firmware components, and wherein the third set of associated embedded firmware components is finger print scanner chipsets (207-3).

9. The portable safety apparatus (200) as claimed in claim 1, wherein the embedded controller module (206-4) comprises a memory unit for storing information and status of each of the items of the movable object (108).

10. The portable safety apparatus (200) as claimed in claim 1, wherein the housing (202) further comprises an alert status lamp provided in the apparatus (200) to locally indicate that at least one of the items is not in communication with the apparatus (200).

11. The portable safety apparatus (200) as claimed in claim 1, wherein the embedded system board (206) further comprises a position detection module and its associated embedded firmware component, wherein the position detection module is one of a GPS module and a GSM module.

12. The portable safety apparatus (200) as claimed in claim 1, wherein the first communication module (206-1) is one of an RFID module (Radio Frequency Identification Module) and an NFC module (Near Field Communication Module).

13. The portable safety apparatus (200) as claimed in claim 12, wherein the RFID modules may include an RFID antenna (208) to transmit and receive information related to one or more items in the movable object (108), wherein the RFID module further includes an integrated circuit for collecting and processing the information relating to the one or more items.

14. The portable safety apparatus (200) as claimed in claim 1, wherein the first communication module is to read a unique identifier of each item associated with the movable object (108), wherein the unique identifier is an RFID tag.

15. The portable safety apparatus (200) as claimed in claim 1, wherein the second communication module (206-2) and its second set of associated embedded firmware components includes a wireless MCU (Master Control Unit) operable with a wireless communication protocol selected from Bluetooth Smart, Zigbee, 6LoWPAN, Zigbee RF4CE, and their like.

16. The portable safety apparatus (200) as claimed in claim 1, wherein the first command is received from the first communication module (206-1) through a first communication protocol (201-1), wherein the second command is received from the second communication module (206-2) through a second communication protocol (201-2), and wherein the third command is received from the third communication module (206-3) through a third communication protocol (201-3).

17. The portable safety apparatus (200) as claimed in claim 16, wherein the third command overrides the first command and the second command.

18. The portable safety apparatus (200) as claimed in claim 1, wherein the embedded system board (206) optionally comprises a fourth communication module as a Wi-Fi module and its associated embedded firmware component.

19. The portable safety apparatus (200) as claimed in claim 1, wherein the embedded controller module (206-4) and its set of associated embedded firmware component are ultra low power microcontrollers or microprocessors.

20. The portable safety apparatus (200) as claimed in claim 9, wherein the memory unit further stores a status of the locking/unlocking unit (204).

21. The portable safety apparatus (200) as claimed in claim 1, wherein the first command is based on a dedicated identifier identified by the first communication module (206-1), wherein the dedicated identifier is an RFID Master Key.

22. The portable safety apparatus (200) as claimed in claim 1, wherein the locking/unlocking unit (204) comprises a motor lock (308), wherein the motor lock (308) is activated by the embedded controller module (206-4) by communicating a trigger signal (201-4) to perform a lock or an unlock operation, wherein the trigger signal (201-4) is initiated based on one of the first communication module (206-1), the second communication module (206-2), and the third communication module (206-3).

23. The portable safety apparatus (200) as claimed in claim 1, wherein the embedded controller module (206-4) communicates a status signal (201-5) in response to the trigger signal (201-4) to activate a local status lamp, wherein the local status lamp is indicative of one of a lock operation or an unlock operation

24. The portable safety apparatus (200) as claimed in claim 22, wherein the motor lock (308) comprises a micro switch, wherein an on/off status of the micro switch is communicated as a status signal (201-5) to the embedded controller module (206-4) in response to the trigger signal (201-4).

25. The portable safety apparatus (200) as claimed in claim 16, wherein the second and third communication protocols (201-2, 201-3) are Universal Asynchronous Receiver/Transmitter (UART), and wherein the first communication protocol (201-1) is a Serial Peripheral Interface (SPI) Bus.

26. The portable safety apparatus (200) as claimed in claim 1, wherein the embedded controller module (206-4) further comprises dedicated pins for connecting to a motor of the locking/unlocking unit (204) to lock and unlock the movable object (108) containing the one or more items to be secured, wherein the dedicated pins are exited for a predetermined period ranging from about 800 to about 1200 milliseconds.

27. The portable safety apparatus (200) as claimed in claim 14, wherein the unique identifier comprises one of a passive tag and an active tag or both.

28. A system (100) for securing a movable object (108) and its associated items, wherein the movable object (108) comprises:
a plurality of associated items, wherein each of the items includes a unique identifier;
an apparatus (200) to receive and transmit identification and status information from each of the items associated with the movable object (108); wherein the apparatus is configured to lock and unlock the movable object (108) based on one or more control commands; and
an external controller (102) comprising a processor and a dedicated application (104) to process the identification and status information and to generate the one more control commands based on the processed information from and to the movable object (108).

29. A method for securing a movable object (108) and its associated items, comprising:
establishing a connection between an external controller (102) and a portable safety apparatus (200);
detecting, by the portable safety apparatus (200), one or more items and their unique identifiers associated with the movable object (108); and
locking and unlocking the movable object (108) by a locking mechanism based on one or more control commands.

30. The method as claimed in claim 29, wherein establishing a connection between the external controller (102) and the portable safety apparatus (200), comprises:
establishing a communication link with the external controller (102) by one or more communication protocols;
sending a first identity of an embedded controller module (206-4) in the portable safety apparatus (200) to the external controller (102);
receiving a second identity of the external controller (102) from the external controller (102) by the embedded controller module (206-4); and
configuring the portable safety apparatus (200) based on an authentication of the first and second identity information.

31. The method as claimed in claim 29, wherein detecting the one or more items and their unique identifiers associated with movable objects (108), comprising:
receiving a RUN command form the external controller (102);
activating an RFID detector based on the RUN command to detect one or more items and their unique identifiers;
determining whether the unique identifier detected is a Master RFID wherein when the detected unique identifier is the Master RFID, performing one of the lock and unlock operation;
wherein when the detected unique identifier is not the Master RFID,
determining whether the unique identifier matches the configured data stored in the portable safety apparatus (200), in the affirmative then, toggling the item detected to an IDENTIFIED list if already in the MISSING listing and toggling the item detected to the MISSING list if already in the IDENTIFIED list; and
communicating the IDENTIFIED and MISSING list to the external controller (102) when a change is detected in the MISSING or IDENTIFIED list.

32. The method as claimed in claim 29, locking and unlocking the movable object (108) by a locking mechanism based on one or more control commands, comprising:
receiving one of a first command, a second command and a third command to perform one of a lock and an unlock operations;
toggling a lock/unlock register based on one of the first command, second command and third command;
wherein when the register is toggled for a lock operation,
locking the movable object (108) by driving a motor lock (308) of the locking/unlocking unit (204) in a clockwise direction; and
wherein, when the register is toggled for an unlock operation,
unlocking the movable object (108) by driving the motor lock (308) of the locking/unlocking unit (204) in an anti-clockwise direction;
communicating a current status of the lock/unlock register to the external controller (102);

33. The method as claimed in claim 32, wherein driving the motor lock (308) comprises actuating a motor lock cam (504) either in a forward or reverse direction.

34. The method as claimed in claim 32, further comprises:
activating a local status lamp based on the current status of the lock/unlock register

35. A movable object (108) for securing one or more items, the movable object (108) comprising a portable safety apparatus (200) as claimed in any one of claims 1 to 27.
